(19) United States
(12) Patent Application Publication
(10) Pub. No.: US 2023/0359072 A1
(43) Pub. Date: Nov. 9, 2023

(54) Acoustically modulated plasmonic optical resonators

(71) Applicant: The Board of Trustees of the Leland Stanford Junior University, Stanford, CA (US)

(72) Inventors: Skyler Selvin, San Jose, CA (US); Mark L. Brongersma, Menlo Park, CA (US); Majid Esfandyarpour, Redwood City, CA (US); Jung-Hwan Song, Palo Alto, CA (US)

(21) Appl. No.: 18/144,090

(22) Filed: May 5, 2023

Related U.S. Application Data
(60) Provisional application No. 63/339,157, filed on May 6, 2022.

(51) Int. Cl. G02F 1/11; G02F 1/00; G01N 21/25

(52) U.S. Cl. CPC G02F 1/11; G02F 1/0054; G01N 21/25; G02F 2203/10; G02F 2202/30

(57) ABSTRACT

We provide plasmonic structures having optical responses that are sensitive to mechanical input(s). Such plasmon resonances can be made sufficiently sensitive to deformation to enable this approach. These structures can be used in active devices, such as an optical metasurface controlled by one or more acoustic inputs, or in passive devices such as an acoustic sensor or mechanical force sensor.

### CROSS REFERENCE TO RELATED APPLICATIONS

This application claims the benefit of U.S. provisional patent application 63/339,157, filed on May 6, 2022, and hereby incorporated by reference in its entirety.

### FIELD OF THE INVENTION

This invention relates to plasmon structures having optical responses that are sensitive to mechanical input(s).

### BACKGROUND

One of the main goals of the modern optics and nanophotonics fields is to provide the ability to control light dynamically at high speed and on the subwavelength scale. The current ability to manipulate light is in its infancy and has not changed significantly since the advent of lenses in prehistoric times. In recent years, optical MEMS (microelectromechanical systems) have emerged and proved to be a powerful tool in controlling light. Optical MEMS, however, are not physically smaller than light, and thus are often large, slow, fragile, and limited in their ability to steer and sculpt the phase front of light. Devices that can sculpt the phase of light over a surface dynamically, and thus completely define and control a light field, are called active photonic metasurfaces. These devices aim to replace bulky and expensive traditional optics, as well as expand our ability to control light beyond what is possible with conventional methods. Such metasurfaces, however, are exceedingly difficult to make as they require the ability to fabricate electrically addressed active optical components much smaller than the wavelength of light. Accordingly, it would be an advance in the art to provide improved control of such metasurfaces.

### SUMMARY

In this work, we provide plasmonic structures having optical responses that are sensitive to mechanical input(s). As seen in the examples below, plasmon resonances can be made sufficiently sensitive to mechanical deformation to enable this approach. Such structures can be used in active devices, such as an optical metasurface controlled by one or more acoustic inputs, or in passive devises such as an acoustic sensor or mechanical force sensor.

In one example, we use surface acoustic waves (SAWs) to mechanically modulate optical resonators over a surface. Surface acoustic waves are mechanical waves of deformation that are bound to the surface of a material and whose displacement amplitude is large at the surface. These waves apply a force varying with space and time to anything placed upon the surface and can have a wavelength smaller than that of optical light. SAWs are typically limited to nanometer level surface displacements, which is typically not enough to significantly modulate light. Thus, we use plasmonics to confine the light and shrink its wavelength on the surface where the SAW exists. We channel incoming light into gap plasmon modes in a metal-dielectric-metal structure. Such modes are extremely sensitive to changes in the size of the gap, and less than 0.1 nm of change can have a significant effect on the optical resonance. The dielectric in the gap was chosen to be mechanically soft and compliant to allow forces from the SAW to deform it and thus change the optical resonance as much as possible.

In this example, the device includes a piezoelectric substrate with a broadband interdigitated transducer sending SAWs to a section containing mechanically compliant gap plasmon resonators. The bottom metal of these resonators is a metal film coating on the piezoelectric substrate, the top metal component is a metal nanoparticle or stripe, and the elastic dielectric is a few nanometers of elastomer/rubber.

Possible commercial applications include, but are not limited to:
1) Optical beam steering,
2) Optical modulation,
3) Light detection and ranging (LIDAR),
4) Dynamic holographic displays,
5) Flat dynamic optics,
6) True dynamic holograms,
7) Strain sensing and strain field imaging,
8) Mechanical properties measurement and mapping quantum emitter modulation,
9) Florescence lifetime modulation, and
10) Coupled exciton resonance modulation.

Significant advantages are provided. Most other attempts at active optical metasurfaces involve an active material that is modulated by electrical gates that are physically on or close to the optical device itself. Thus, the modulation electronics must be incorporated into the optical metasurface itself, therefore interfering with the performance of the optical elements. Our approach allows the electronics to be displaced from the metasurface, and the SAWs can be generated far away then propagated onto the desired area. Additionally, our device operates faster than many competing technologies, and is switchable with GHz bandwidths. Using acoustics, we can generate an arbitrary stress field on a surface, and the acoustically sensitive optical resonators on that surface can be accessed at random with a resolution approximately equal to that of the acoustic wavelength. This allows the optical resonators to be individually and independently controlled.

The preceding example relates to surface acoustic waves used to control a photonic metasurface. This idea can be generalized in various ways. For example, any kind of acoustic wave can be used as the driver, not just a surface acoustic wave. Another possible generalization is to acoustic drive of a single-element opto-mechanical resonator. Here the advantages of remote placement of the electronics and high drive speed are as relevant for the single-resonator case as they are for an array of opto-mechanical resonators.

### BRIEF DESCRIPTION OF THE DRAWINGS

FIGS. 1A-B schematically show two embodiments of the invention.

FIG. 2A schematically shows a gap plasmon resonator.

FIG. 2B shows an exemplary structure for making gap plasmon resonators.

FIG. 2C shows acoustic control of a metasurface including gap plasmon resonators.

FIG. 3 is a simulation of the effect of gap size on optical scattering for an exemplary plasmonic resonator.

FIGS. 4A-B show an exemplary application of an acoustically controlled metasurface to optical beam steering.

FIG. 5 shows several acoustic inputs provided to a single optical metasurface.

FIG. 6 is measured data showing a resonance shift caused by an acoustic input to a gap plasmon resonator.

FIGS. 7A-B show measured data showing time dependence of optical scattering in an acoustically driven gap plasmon resonator.

FIG. 8 is measured data showing spectral dependence of scattering by an acoustically driven gap plasmon resonator.

### DETAILED DESCRIPTION

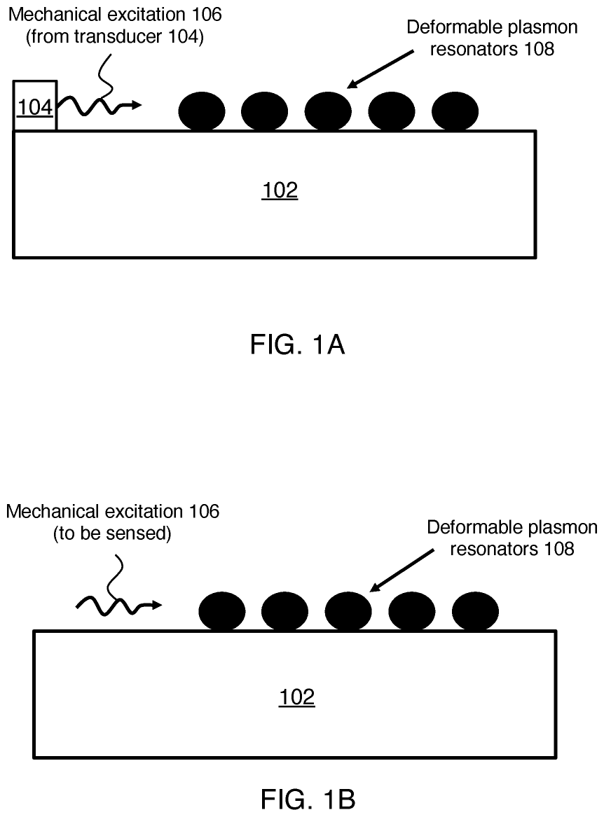

FIGS. 1A-B show two examples of our concept. On FIG. 1A, an acoustic transducer 104 and deformable plasmon resonators 108 are disposed on substrate 102, and mechanical excitation 106 from transducer 104 (typically an acoustic wave) alters the optical responses of resonators 108. The configuration of FIG. 1A relates to active devices, where the acoustic input(s) control the optical properties of the device.

On FIG. 1B there is no transducer. Instead, mechanical excitation 106 is to be sensed by its effect on the optical properties of the device. The configuration of FIG. 1B relates to passive devices, where the mechanical input(s) are signals to be sensed via their effect on the optical properties of the device.

In general, any structure where mechanical deformations change the structure, and thereby also change the resonant frequency of a plasmonic optical resonator, can be used. Changing the resonant frequency of a plasmon resonance can be used to provide control of optical phase and amplitude

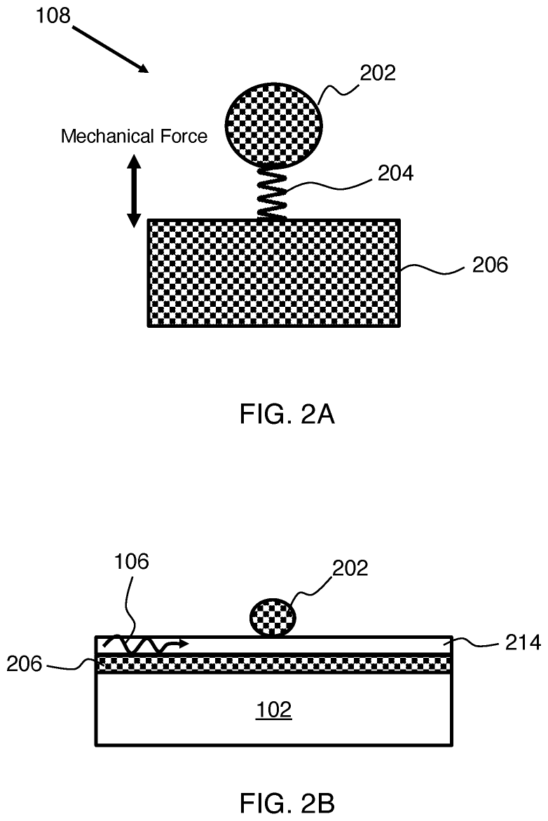

FIG. 2A schematically shows an exemplary deformable plasmon resonator 108. Here 202 and 206 are both plasmonic materials, while 204 schematically shows a restoring force for the gap between materials 202 and 206. Suitable plasmonic materials include, but are not limited to: gold, silver, aluminum, copper, transition metal nitrides, graphene, doped semiconductors such as indium tin oxide (ITO) and aluminum-doped zinc oxide (AZO). Application of a mechanical excitation to such a structure (either a static mechanical force or a time-varying acoustic force) changes the gap between materials 202 and 206, thereby altering the optical properties of the plasmon resonance. Although such gap resonators are a preferred embodiment, practice of the invention does not require a gap plasmon structure.

FIG. 2B shows an exemplary implementation of the structure of FIG. 2A. Here 102 is the substrate, plasmonic material 206 is configured as a uniform layer on substrate 102, an elastic material 214 is configured as a uniform layer on plasmonic material 206, and plasmonic material 202 is configured as one or more sub-wavelength features disposed on elastic material 214. Suitable elastic materials include, but are not limited to: elastomers (such as rubber, silicone), viscoelastic polymers, polymers, ligands, self-assembled monolayers, and non-organic soft materials. More generally, the Young's modulus of the elastic material should be less than the Young's modulus of the plasmonic materials. In this example, the resonances are defined by the gaps between plasmonic material 202 and plasmonic material 206, and are therefore localized, even though plasmonic material 206 is configured as a uniform layer. In operation, substrate 102 guides the acoustic energy into the gap plasmon resonator. The gap will deform under acoustic force, which causes the distance between a plasmonic particle 202 and the plasmonic substrate cladding 206 to change, thus changing the plasmonic mode resonance.

FIG. 2C shows a top view of acoustic control of an optical metasurface 220. Here optical metasurface 220 includes an array 222 of gap-plasmon resonators as described above in connection with FIG. 2B. FIG. 2C shows an irregular array of metasurface features. It is also possible for this array to be regular. In operation, interdigitated acoustic transducer 230 sends acoustic wave 106 into optical metasurface 220. Here an optical metasurface is a two-dimensional, ultra-thin structure with engineered subwavelength features that can manipulate the properties of light, such as its phase, amplitude, and polarization.

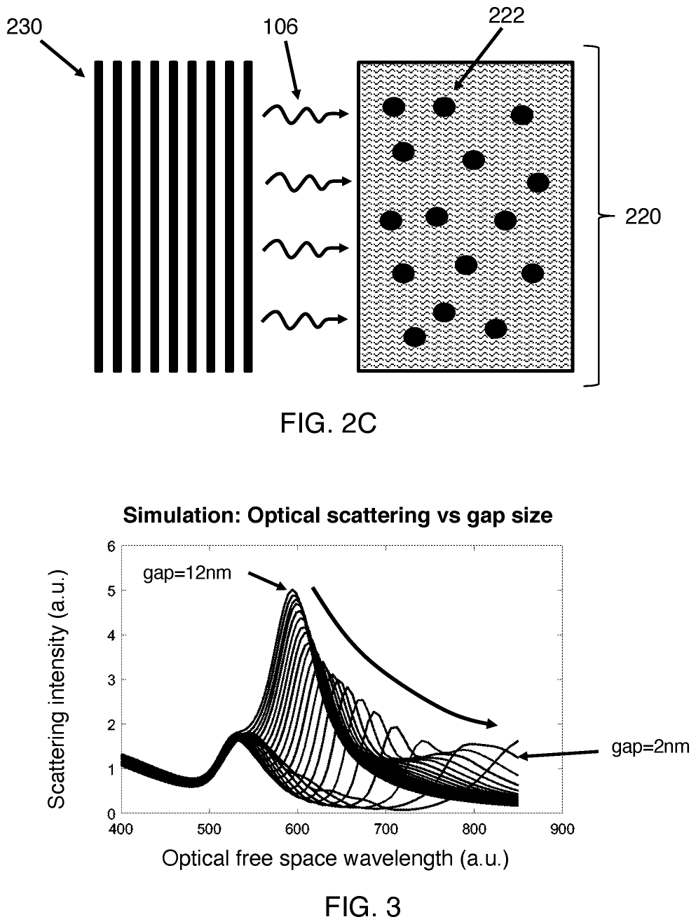

FIG. 3 shows simulations of the scattering intensity of a 100 nm Au nanosphere over an Au substrate, separated by a dielectric gap of refractive index of 1.45. This shows how the plasmonic resonances shift with nanometer changes in gap size.

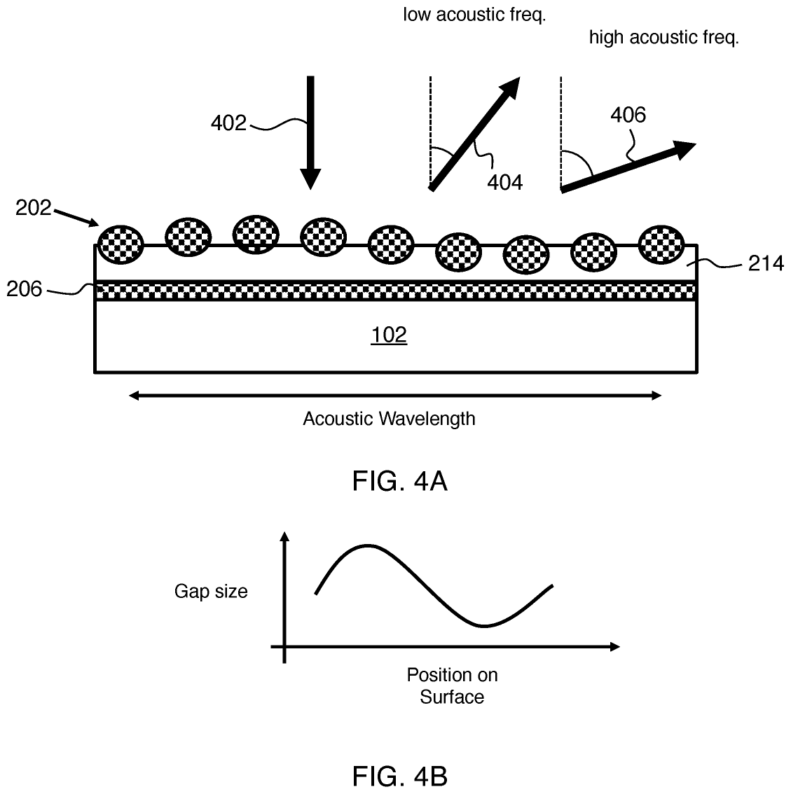

FIGS. 4A-B schematically show how acoustically driven optical metasurfaces can be used for beam steering. The acoustic waves will impart a change in gap size over the surface that is dependent on the acoustic wave amplitude at that point in space and time. Thus, the gap size for different optical resonators, and thus the optical resonant frequency, is dependent on the acoustic mode shape. FIG. 4B shows an example of gap size vs. position, where the gap size change is spatially dependent on the acoustic amplitude. Thus, we can create periodically varying optical scattering amplitude and phase by using a periodic acoustic mode shape over the surface. By varying this acoustic mode shape, say, by varying the frequency of the acoustic wave, we can vary the optical scattering period and therefore create an acoustically controlled beam steering device. Thus, in the example of FIG. 4A, incident light 402 can be deflected such that output light is at angle 404, or at angle 406 (or at any other angle, in principle) by altering the acoustic frequency. As acoustic frequency increases, the optical deflection angle (relative to specular reflection) increases. Thus, the acoustic frequency that generates deflection at angle 406 is greater than the acoustic frequency that generates deflection at angle 404.

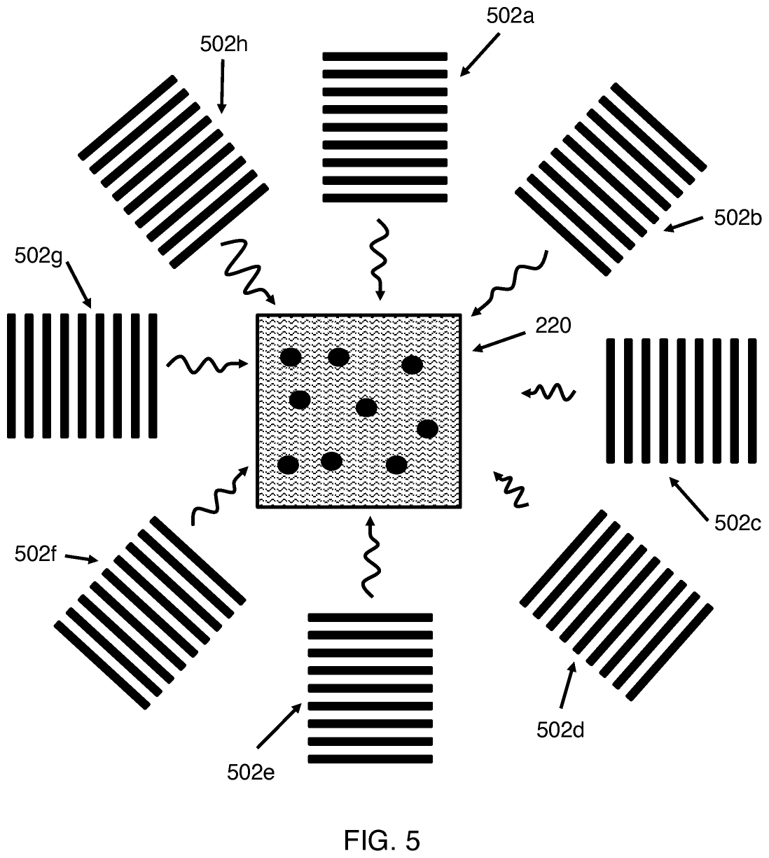

The example of FIG. 5 shows we can use many acoustic transducers (i.e., transducers 502a, 502b, 502c, 502d, 502e, 502f, 502g, 502h) to create an arbitrary acoustic profile in metasurface 220. This will in turn create a corresponding arbitrary optical scattering amplitude/phase profile over the surface which can be used for dynamic holography, beam steering, etc.

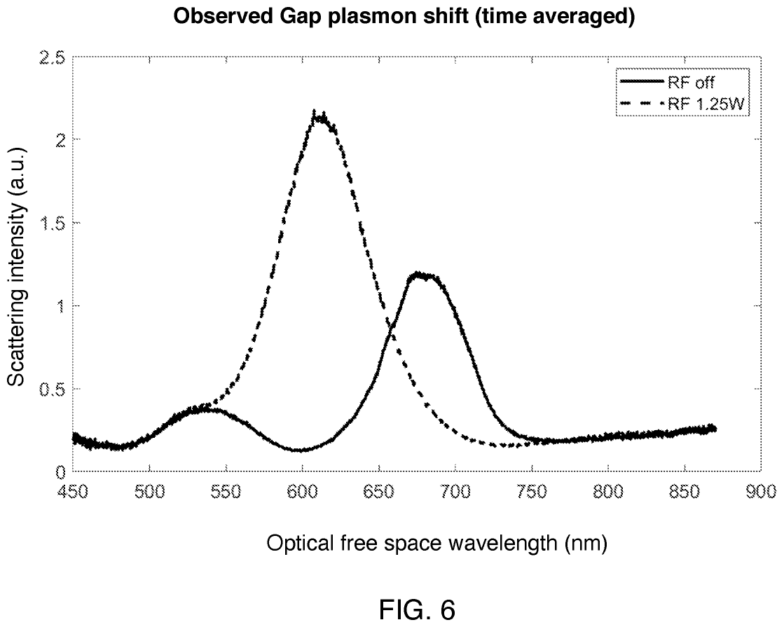

FIG. 6 shows the measured time averaged spectrum of a single gap plasmon resonator (gold nanoparticle on mirror separated by silicone) when the acoustic wave is off, and when the acoustic wave is on at 1.25 W incident RF power around 600 MHz. We see an extremally large shift in the gap plasmon resonance, where one of the modes shifts by over 100 nm

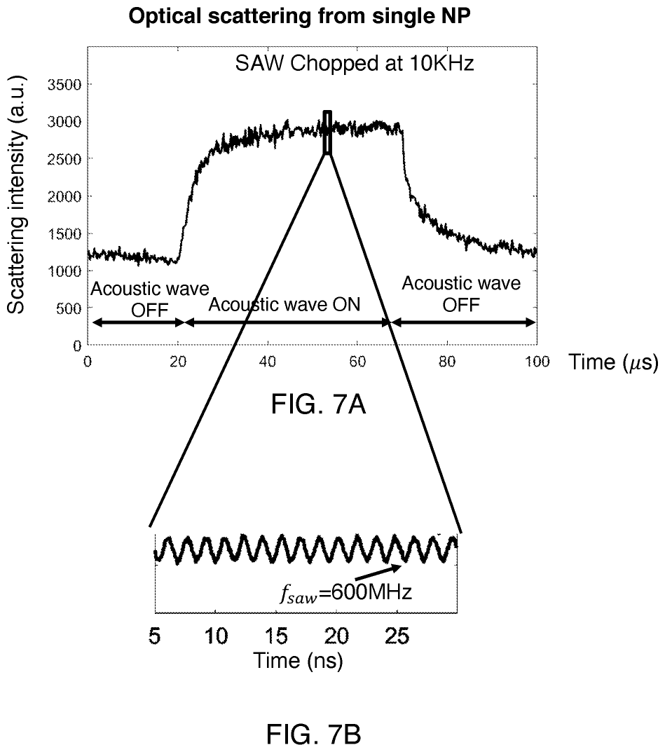

FIGS. 7A-B show measured results for a SAW wave input at constant frequency (600 MHz) that is chopped (i.e., turned on and off) at 10 Khz with a 50% duty cycle. We look at the light scattered by a single gap plasmon resonator at a single illumination wavelength. We see two different time scales for the scattering intensity modulation. When the SAW is immediately turned on, it takes a few microseconds for the scattering intensity to change more than 100% its original value (FIG. 7A). There is also very high frequency scattering modulation at the SAW frequency as well, but it is only around 20% scattering modulation (FIG. 7B).

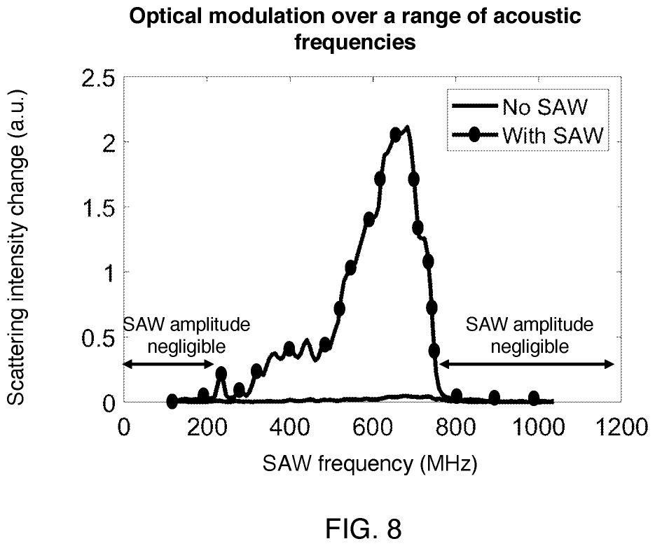

FIG. 8 shows a measurement of average response of several deformable gap plasmon resonators vs. the incident surface acoustic wave frequency. We can see that the amount that the optical scattering is modulated by the acoustic wave is different for different acoustic frequencies. The acoustic wave is approximately constant amplitude over the range of frequencies 200-700 MHz, and approximately zero outside this range of frequencies.

1. Apparatus comprising:
an optical structure having one or more sub-wavelength features disposed on a substrate, wherein each feature has one or more corresponding plasmon resonances; and
an acoustic transducer configured to provide an acoustic excitation to the optical structure;
wherein each feature has an optical spectral response that can be altered by the acoustic excitation via modulation of the corresponding plasmon resonances.

2. The apparatus of claim 1, wherein the optical structure is configured as an optical metasurface including two or more sub-wavelength features disposed on a substrate.

3. The apparatus of claim 1, wherein each feature includes a metal-dielectric-metal layer stack having a gap defined by the dielectric, and wherein the plasmon resonances of each feature are affected by the corresponding gaps.

4. The apparatus of claim 1, wherein the substrate is piezoelectric.

5. The apparatus of claim 1, wherein the acoustic excitation includes acoustic signals having one or more distinct periods.

6. The apparatus of claim 5, wherein the one or more distinct periods are in one or more different lateral directions.

7. The apparatus of claim 1, wherein the apparatus is configured to provide characterization of elastic properties of the sub-wavelength features.

8. The apparatus of claim 1, wherein the apparatus is configured to provide an optical functionality selected from the group consisting of: optical beam steering, optical modulation, light detection and ranging, dynamic holographic displays, flat dynamic optics, true dynamic holograms, fluorescence lifetime modulation, and coupled exciton resonance modulation.

9. The apparatus of claim 1, wherein the acoustic excitation is selected from the group consisting of: surface acoustic waves, Love waves, transverse bulk acoustic waves, longitudinal bulk acoustic waves, Stonely waves and Lamb waves.

10. A sensor comprising:
an optical structure having one or more sub-wavelength features disposed on a substrate;
wherein each feature has one or more corresponding plasmon resonances;
wherein each feature has an optical spectral response that can be altered by an incident mechanical excitation via modulation of the corresponding plasmon resonances,
whereby sensing of the incident mechanical excitation is provided.

11. The sensor of claim 10, wherein the mechanical excitation is selected from the group consisting of: static mechanical forces and acoustic excitations.
